(19) United States
(12) Patent Application Publication
(10) Pub. No.: US 2011/0013528 A1
(43) Pub. Date: Jan. 20, 2011

(54) METHOD FOR PROVIDING PRESENCE AND LOCATION INFORMATION OF MOBILES IN A WIRELESS NETWORK

(76) Inventor: Byron H. Chen, Whippany, NJ (US)

Correspondence Address: HARNESS, DICKEY & PIERCE, P.L.C., P.O. BOX 8910, RESTON, VA, 20195, US

(21) Appl. No.: 12/701,596

(22) Filed: Feb. 7, 2010

Related U.S. Application Data
(60) Provisional application No. 61/271,054, filed on Jul. 16, 2009.

(51) Int. Cl. H04J 3/14; H04W 4/00

(52) U.S. Cl. 370/252; 370/329

(57) ABSTRACT

In one embodiment, the method includes collecting, at the base station, presence information for each of the plurality of mobile devices, respectively. Location information is collected at the base station for each of the plurality of mobile devices, respectively. Integrated information is generated at the base station for each of the plurality of mobile devices, respectively, based on the collected presence and location information.

### PRIORITY INFORMATION

This U.S. non-provisional patent application claims priority under 35 U.S.C. §119 of U.S. provisional patent application No. 61/271,054, filed on Jul. 16, 2009, the entire contents of which are incorporated herein by reference.

### BACKGROUND OF THE INVENTION

1. Field

Example embodiments of the present invention relate generally to providing presence and location information of mobiles in wireless networks.

2. Related Art

Some advanced location based service (LBS) applications use mobile unit presence and location information. These advanced applications may need the presence information, for example, active or idle status, particular activities, etc, of multiple mobiles in a wireless network associated with the mobiles' locations.

Conventional solutions for providing location and presence information for mobile units include a control plane solution and a user plane solution. The control plane solution, introduced in 2G networks, uses a know control plane architecture and includes implementing location calculation algorithms at an evolved serving mobile location center (E-SMLC). The user plane solution, introduced in 3G networks, uses a known user plane architecture and includes implementing location calculating algorithms at a secure user plane location (SUPL) location platform (SLP).

Some conventional mobile devices are configured to access both control plane architectures and separately implemented user plane architectures in order to support advanced applications requiring location and/or presence information. However, both the user plane solution and the control plane solution are designed to satisfy individual mobile location service. Neither one of the user plane and control plane solutions can provide statistics of presence and location for many mobiles effectively, due to the lack of a mechanism for obtaining information for multiple mobiles and high cost associated with obtaining the location and presence information for many mobiles using the conventional solutions. Further, the user plane approach has the added disadvantage of less robust support for emergency location services such as enhanced 911 (E911).

### SUMMARY OF THE INVENTION

One or more embodiments relate to a method of generating integrated location and presence information for a plurality of mobile devices.

In one embodiment, the method includes collecting presence information for each of the plurality of mobile devices, respectively, at the base station. Location information is collected at the base station for each of the plurality of mobile devices, respectively. Combined information is generated at the base station for each of the plurality of mobile devices, respectively, based on the collected presence and location information.

According to another embodiment, generating the integrated information includes generating, for each of the plurality of mobile devices, an information vector associated with each of the plurality of mobile devices. The information vector is generated based on the collected presence and location information. The information vector includes an identifier identifying the associated mobile device from among the plurality of mobile devices and time information indicating a time period during which presence and location information was collected.

According to another embodiment, the method includes performing call processing for each of the plurality of mobile devices. The presence information is collected based on the call processing.

According to another embodiment, for each of the plurality of mobile devices, the presence information collected for the mobile device includes information regarding an activity of the mobile device.

According to another embodiment, the activity of the mobile device is one of participating in a voice call, texting and accessing the internet.

According to another embodiment, collecting the location information includes using a geolocation function.

According to another embodiment, using the geolocation function includes using location technologies that do not require user's consent including uplink observed time difference on arrival (U-OTDOA) and/or enhanced cell identification (ECID).

According to another embodiment, the method includes providing the information vectors generated to each of the plurality of mobile devices to a management entity.

According to another embodiment, the method includes generating, at the management entity, an information flow based on the information vectors generated for each of the plurality of mobile devices.

According to another embodiment, the method includes providing one or more subscriptions to subscribers. The subscriptions allow the subscribers to access data based on the information flow. The method also includes providing the information flow to one or more servers associated with the subscribers.

According to another embodiment, the method includes providing the information flow to an enhanced serving mobile location center (E-SMLC).

According to another embodiment, the method includes providing the information flow to a secure user plane location (SUPL) location platform (SLP).

According to another embodiment, the method includes providing the information flow to a network component configured to perform the functions of both an E-SMLC and SLP.

One or more embodiments relate to a method of providing combined location and presence information for a plurality of mobile devices to a subscriber. The plurality of mobile devices are operating on a wireless network. An access request is received at a network element from a subscriber. The access request requests access to the combined location and presence information. The network element is connected to the wireless network. Access to the combined location and presence information is provided from the network element.

According to another embodiment, the network element is a management entity.

According to another embodiment, the network element is configured to perform the functions of both an evolved serving mobile location center (E-SMLC) and a secure user plane location (SUPL) location platform (SLP).

According to another embodiment, the access request includes an indication of a subset of information desired by the subscriber. Further, the providing step includes generating filtered information by applying a filtering operation to the combined location and presence information. The filtered information is provided to the subscriber.

According to another embodiment, the combined location and presence information requested by the access request is previously stored information. The providing step includes retrieving the previously stored information from a data base within the wireless network, and providing the retrieved information to the subscriber.

One or more example embodiments relate to a method of handling an emergency call from a mobile device on a wireless network having a unified architecture, the method comprising. The method may include receiving a request for routing information for a public safety answering point (PSAP) from an IP multimedia subsystem (IMS) at an integrated network element. The integrated network element is associated with the wireless network and is configured to perform the functions of both an evolved serving mobile location center (E-SMLC) and a secure user plane location (SUPL) location platform (SLP). The request for routing information is associated with the emergency call. The integrated network element attempts to determine a location of the mobile device using a first process. The integrated network element determines whether the location of the mobile device was successfully determined using the first process. The integrated network element determines the location of the mobile device using a second process if the first process is determined not be successful. The integrated network element determines the routing information for the PSAP based on the determined location of the mobile device. The routing information for the PSAP is sent to the IMS so the IMS can connect the emergency call to the PSAP.

According to another embodiment, the integrated network element includes an E-SMLC unit for implementing the functions of an E-SMLC and an SLP unit for implementing the functions of an SLP. The first process includes determining the location of the mobile device using the SLP, and the second process includes determining the location of the mobile device using the E-SMLC.

### BRIEF DESCRIPTION OF THE DRAWINGS

Example embodiments of the present invention will become more fully understood from the detailed description provided below and the accompanying drawings, wherein like elements are represented by like reference numerals, which are given by way of illustration only and thus are not limiting of the present invention and wherein:

FIG. 1 illustrates a portion of a wireless communications network 100 having a unified architecture.

FIG. 2A illustrates an example format for a unit of presence information generated by the call processing unit 130.

FIG. 2B illustrates an example format for a unit of location information generated by the geolocation unit 120.

FIG. 3 illustrates, as an example of an information vector generated by the data synthesis unit 140.

FIG. 4 is a flow chart illustrating a method of generating location/presence information.

FIG. 5A is a flow chart illustrating a method of providing combined location and presence information to a subscriber.

FIG. 5B is a flow chart illustrating a method of providing a requested subset of the combined location and presence information to a subscriber.

FIG. 5C is a flow chart illustrating a method of providing previously stored combined location and presence information to a subscriber.

FIG. 6A is a flow chart illustrating a method of supporting E911 services using a user plane approach.

FIG. 6B is a flow chart illustrating a method of supporting E911 services using a control plane approach.

FIG. 7 is a flow chart illustrating a method of supporting E911 services using a combined user plane and control plane approach.

### DETAILED DESCRIPTION OF EXAMPLE EMBODIMENTS

Detailed illustrative embodiments of the present invention are disclosed herein. However, specific structural and functional details disclosed herein are merely representative for purposes of describing example embodiments of the present invention. This invention may, however, be embodied in many alternate forms and should not be construed as limited to only the embodiments set forth herein.

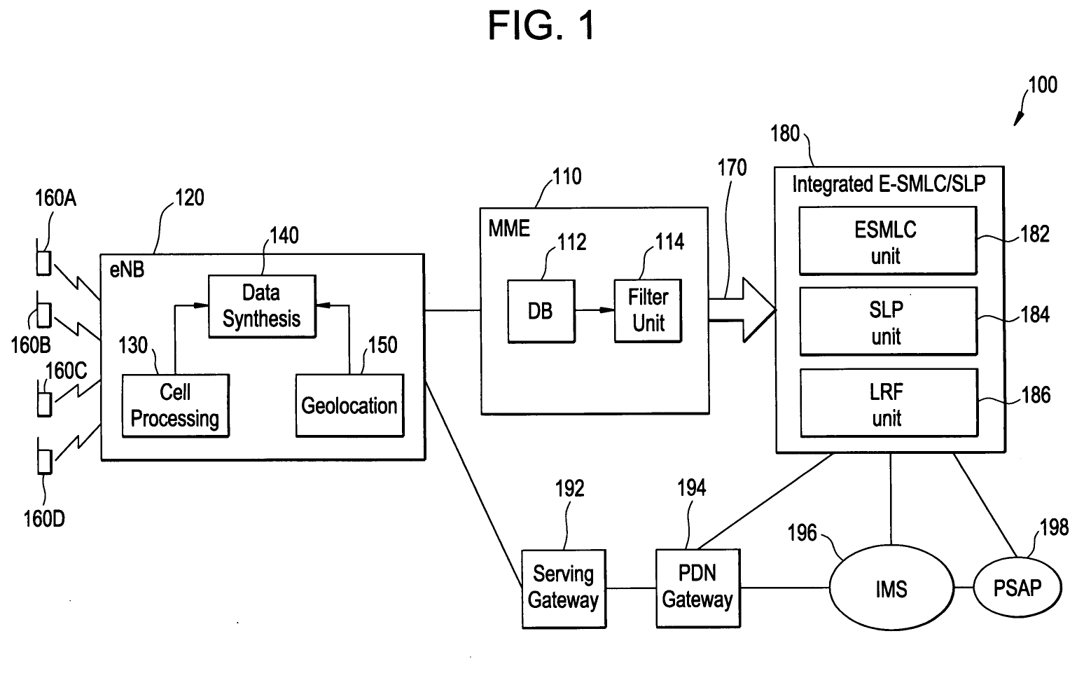

FIG. 1 illustrates a portion of a wireless communications network 100 having a unified architecture. Wireless communications network 100 may follow, for example, an LTE protocol. Wireless communications network 100 includes a mobility management entity (MME) 110, an evolved node B (eNB) 120, a plurality of user equipments (UEs) 160A˜D, an integrated evolved serving mobile location center (E-SMLC)/secure user plane location (SUPL) location platform (SLP) 180, a serving gateway 192, a public data network (PDN) gateway 194, an IP multimedia subsystem (IMS) 196, and a public safety answering point (PSAP) 198.

As used herein, the term “user equipment (UE)” may be considered synonymous to, and may hereafter be occasionally referred to, as a mobile device, mobile station, mobile user, subscriber, user, remote station, access terminal, receiver, etc., and may describe a remote user of wireless resources in a wireless communication network. The term “evolved Node B (eNB)” may be considered synonymous to and/or referred to as a base transceiver station (BTS), NodeB, femto cell, access point, etc. and may describe equipment that provides the radio baseband functions for data and/or voice connectivity between a network and one or more users.

The UEs 160A˜D are in wireless communication with the eNB 120. The eNB 120 is connected to the MME 110. The MME 110 is connected to the Integrated E-SMLC/SLP. Though not pictured, wireless communications network 100 may include other elements of an LTE core network in addition to MME 110. The UEs 160A˜D may be, for example, mobile phones, smart phones, computers, or personal digital assistants (PDAs).

The eNB 120 is also connected to a serving gateway 192. The serving gateway 192 is capable of routing and forwarding user data packets of UEs connected to the eNB 120. The serving gateway 192 provides access for the eNB 120 to the PDN gateway 194. The PDN gateway 194 provides access to other packet data networks for the eNB 120 via the serving gateway 192. The PDN gateway 194 is connected to the integrated E-SMLC/SLP 180 and the IMS 196. The IMS 196 includes a number of network nodes and provides access to the internet for mobile devices, for example UEs 160A˜D, via the eNB 120, the serving gateway 192 and the PDN gate way 194. The IMS 196 is connected to the integrated E-SMLC/SLP 180 and the PSAP 198. The PSAP 198 handles calls for emergency assistance. The PSAP 198 may be, for example, a call center responsible for receiving and responding to calls requesting emergency services. Emergency services include, for example, services requiring firefighters, police, medical assistance, etc.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

### Generating Integrated Location and Presence Information

The eNB 120 according to example embodiments of the present invention is configured to generate integrated location and presence information. Examples of the structure and operation of the eNB 120, and example formats for the integrated location and presence information generated by the eNB 120 according to example embodiments of the present invention will now be discussed in greater detail. Though, for the purpose of simplicity, only four UEs 160A˜D are shown in FIG. 1, eNB 120 may be in wireless communication with any number of UEs. The eNB 120 includes a call processing unit 130, a geolocation unit 150 and a data synthesis unit 140. Though, only one eNB 120 is illustrated as being connected to the MME 110 in FIG. 1, the wireless communications network 100 may include any number of eNBs connected to the MME 110. Each eNB may operate in the same manner as the eNB 120.

The call processing unit 130 includes hardware and/or software capable of handling call processing for all of the mobiles in wireless communication with the eNB 120. The call processing unit 130 includes hardware and/or software capable of collecting presence information associated with each of the UEs in communication with the eNB 120. Presence information gathered by the call processing unit 130 may include, for example, information regarding whether a UE is active or idle. Presence information gathered by the call processing unit 130 may also include information about activities being performed by a UE including, for example, whether a UE is participating in a voice call, texting, downloading or streaming videos, browsing a website, etc.

The call processing unit 130 may determine an activity of a mobile by analyzing a quality of service (QoS) associated with a UE. For example, when a mobile device requests a particular service from the eNB, the mobile device requests a desired QoS by specifying a particular QoS class identifier (QCI). According to 3GPP TS 23.203, each QCI is associated with a particular set of service quality parameters including, for example, a guaranteed bit rate (GBR), packet delay budget (PDB), and packet loss rate (PLR). Accordingly, UEs choose which QCI to request based on the needs of the service requested by the UE (e.g., voice, video, text, web surfing, etc.). Thus, the call processing unit 130 is capable of determining the type of service each UE is participating in by analyzing the QCI requested by each UE. The presence information collected by the call processing unit 130 includes a UE identifier which is a temporary identification associated with the UE to which the collected presence information corresponds. The call processing unit 130 provides the collected presence information including the corresponding UE identifiers to the data synthesis unit 140.

The geolocation unit 150 includes hardware and/or software capable of determining location information associated with each of the UEs in communication with the eNB 120. The geolocation unit 150 may support any type of known geolocation functions including, for example, GPS. According to some embodiments it is desirable for the geolocation unit 150 to support geolocation functions which do not require consent from a UE in order to operate including, for example, uplink observed time difference on arrival (U-OTDOA) and enhanced cell identification (ECID). The geolocation information collected by the geolocation unit 150 includes a UE identifier which is a temporary identification associated with the UE to which the location information corresponds. The geolocation unit 150 provides the collected location information including the corresponding UE identifiers to the data synthesis unit 140.

The data synthesis unit 140 includes hardware and/or software capable of creating information vectors for each of the UEs in communication with the eNB 120 based on the presence information provided by the call processing unit 130 and the location information provided by the geolocation unit 150.

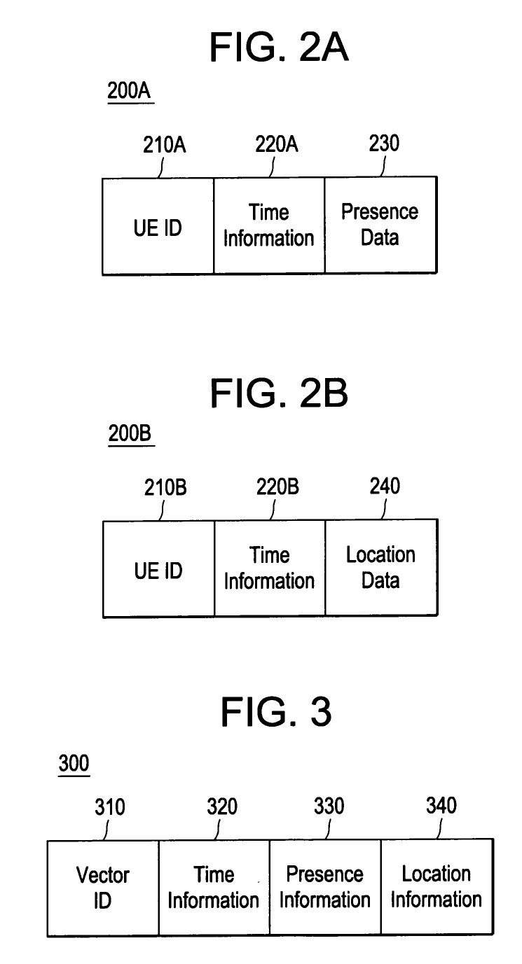

The data synthesis unit 140 may generate vectors corresponding to a plurality UEs in communication with the eNB 120, respectively. For example, the data synthesis unit 140 may generate a vector for each UE in communication with the eNB 120. The data synthesis unit 140 may generate the vectors continuously. Though not illustrated, the eNB 120 may include storage for storing the vectors generated by the data synthesis unit 140. The eNB 120 provides the vectors generated by the data synthesis unit 100 to the MME 110. Information vectors created by the data synthesis unit 140 are discussed in greater detail below with reference to FIGS. 2A-2B.

Example formats for information generated by the call processing unit 130, geolocation unit 150, and data synthesis unit 140 of the eNB 120 will now be described with reference to FIGS. 2A, 2B and 3.

FIG. 2A illustrates an example format for a unit of presence information 200A generated by the call processing unit 130. As shown, presence information unit 200A includes a UE identification field 210A, a time information field 220A, and a presence data field 230. As an example, presence information unit 200A will be described as if the presence information unit 200A was generated for the UE 160A in wireless communication with the eNB 120.

The UE ID field 210A includes identification information identifying the UE 160A. According to some example embodiments, the identification information included in the UE ID field 210A may be a temporarily assigned identification, which uniquely identifies the UE 160A with respect to all other UEs in wireless communication with the eNB 120. As another example, identification information in the vector ID field 210A may include the International Mobile Subscriber Identity (IMSI), International Mobile Equipment Identity (IMEI), etc. of the UE 160A. Further, according to some example embodiments, it may be desirable for the identification information included in the vector ID field 210A to include cell identification and/or eNB identification to differentiate the data collected for the UE 160A from data collected for other UEs in cells associated with eNBs other that the eNB 120. The time information field 220A includes an indication of time information associated with presence information 200A including, for example, a time the presence data in the presence information 200A was collected or a time interval in which the presence information in the presence information 200A was collected. The presence data field 230 includes an indication of the presence associated with the UE 160A based on the presence information generated by the call processing unit 130. For example, the presence data field 230 may include information indicating whether UE 160A was active or idle. The presence data field 230 may also include information indicating an activity being performed by the UE 160A including, for example, whether the UE 160A is participating in a voice call, texting, downloading videos, browsing a website, etc.

FIG. 2B illustrates an example format for a unit of location information 200B generated by the geolocation unit 120. As shown, location information unit 200B includes a UE identification field 210B, a time information field 220B, and a location data field 240. As an example, the location information unit 200B will be described as if the location information unit 200B was generated for the UE 160A in wireless communication with the eNB 120.

The UE ID field 210B includes identification information identifying the UE 160A. The UE ID field 210B may include the same type of identification information as the UE ID field 210A discussed above with reference to FIG. 2A. According to some example embodiments, the identification information included in the UE ID field 210A may be a temporarily assigned identification which uniquely identifies the UE 160A with respect to all other UEs in wireless communication with the eNB 120. As another example, identification information in the vector ID field 210B may include the International Mobile Subscriber Identity (IMSI), International Mobile Equipment Identity (IMEI), etc. of the UE 160A. Further, according to some example embodiments, it may be desirable for the identification information included in the vector ID field 210B to include cell identification and/or eNB identification to differentiate the data collected for the UE 160A from data collected for other UEs in cells associated with eNBs other that the eNB 120. The time information field 220B includes an indication of time information associated with location information 200B including, for example, a time the location data in the location information 200B was collected or a time interval in which the location data in the location information 200B was collected. The location data field 240 includes an indication of the location of the UE 160A based on location information generated by the geolocation unit 150. For example, the location information may be coordinates, longitude/latitude information, etc.

FIG. 3 illustrates, as an example of an information vector generated by the data synthesis unit 140. The data synthesis unit 140 generates information vectors based on presence information received from the call processing unit 130 and location information received from that geolocation unit 150. As an example, the information vector 300 will be described as if the information vector 300 was generated for the UE 160A, in wireless communication with the eNB 120, after processing the presence information unit 200A generated by the call processing unit 130 and the location information unit 200B generated by the geolocation unit 150. For example, the data synthesis unit 140 may form the information vector 300 by correlating a unit of presence information 200A with a unit of location information 200B by matching the UE IDs 210A and 210B, as well as the time information 220A and 220B. As shown, information vector 300 includes, for example, a vector ID field 310, a time information field 320, a presence information field 330, and a location information field 340 each associated with the UE for which the vector 300 was generated.

The vector ID field 310 includes identification information identifying the UE 160A. The identification information in the vector ID field 310 may include the same temporary identification information used in the UE ID 210A and 210B discussed above with reference to FIGS. 2A and 2B. As another example, identification information in the vector ID field 310 may include the International Mobile Subscriber Identity (IMSI), International Mobile Equipment Identity (IMEI), etc. of the UE 160A. Further, according to some example embodiments, it may be desirable for the identification information included in the vector ID field 310 to include cell identification and/or eNB identification to differentiate the data collected for the UE 160A from data collected for other UEs in cells associated with eNBs other that the eNB 120. The time information field 320 includes an indication of time information associated with the vector 300. For example, the time information within the time information field 320 may be generated based on the information within time information 220A and time information filed 220B associated with the presence information 200A and location information 200B, respectively. The presence information field 330 includes an indication of the presence associated with the UE 160A based on the presence data 230 within the presence information unit 200A. For example, the presence information field 330 may include information indicating whether UE 160A was active or idle. The presence information field 330 may also include information indicating an activity being performed by the UE 160A including, for example, whether the UE 160A is participating in a voice call, texting, downloading videos, browsing a website, etc. The location information field 340 includes an indication of the location of the UE 160A based on the location data 240 within the location information 200B. For example, the location information within the location information field 340 may be coordinates, longitude/latitude information, etc.

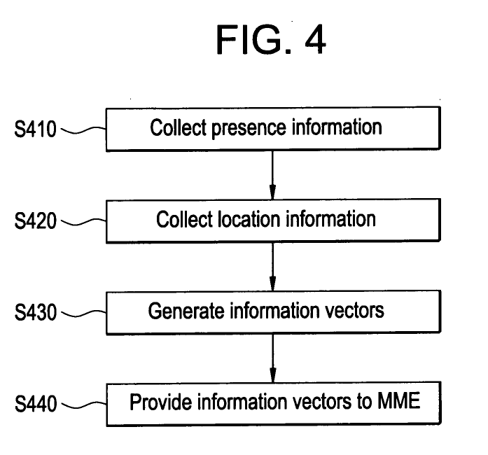

An example of the operation of the eNB 120 will now be described with reference to FIGS. 1 and 4. FIG. 4 is a flow chart illustrating a method of generating location/presence information.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

In the example illustrated in FIG. 4, it is assumed that the eNB 120 is in wireless communication with UEs 160A-160D and handles call processing for UEs 160A-160D. Though, for the purpose of simplicity, the method illustrated in FIG. 4 is explained with reference to only four UEs 160A-160D, the method illustrated in FIG. 4 may be applied to any number of UEs which are in wireless communication with an eNB in accordance with the present invention.

In step S410, the call processing unit 130 of the eNB 120 collects presence information for each of UEs 160A-160D. As is described above with reference to FIG. 1, the call presence information includes information regarding the activity of each of the UEs 160A-160D. The call processing unit 130 provides the collected presence information to the data synthesis unit 140. The collected presence information may be provided to the data synthesis unit 140 in the form of the presence information unit 220A.

In step S420, the geolocation unit 150 of the eNB 120 collects location information for each of the UEs 160A-160D. As is described above with reference to FIG. 1, the geolocation unit 150 collects the location information using, for example, known geolocation functions which do not require consent from UEs in order to operate. The call processing unit 130 provides the collected location information to the data synthesis unit 140 in the form of the location information unit 220B. The collected location information may be provided to the data synthesis unit 140 in the form of the location information unit 220B.

Though steps S410 and S420 are illustrated as being performed sequentially, steps S410 and S420 may also be performed continuously and/or simultaneously for each of a plurality of time intervals over which the method illustrated in FIG. 2 is performed.

In step S430, the data synthesis unit 140 creates information vectors based on the presence and location information received from the call processing unit 130 and geolocation unit 150, respectively. The data synthesis unit creates an information vector for each of the UEs in wireless communication with the eNB 120, UEs 160A-160B. For each generated information vector, the data syntheses unit 140 matches a received unit of presence information 200A with a received unit of location information 200B based on the UE ID fields 210A and 210B as well as the time information fields 220A and 220B. The data synthesis unit 140 then associates the information in the presence data field 230 of the unit of presence information 200A, and the information in the location data field 240 of the unit of location information 200B with a vector ID identifying the UE with which the presence and location data is associated. The data synthesis unit 140 then populates the vector ID filed 410, presence information field 430, location information field 440 and time information field 420 of each vector. As is discussed above with reference to FIG. 1, the eNB 120 may include storage for storing the information vectors generated by the data synthesis

In step S440, the eNB 120 sends the information vectors generated in step S430 to the MME 110. According to some embodiments, the eNB 120 may provide the information vectors generated by the data synthesis unit 100 to the MME 110 upon receiving a request from the MME 110. According to some embodiments, the eNB 120 may provide the information vectors generated by the data synthesis unit 140 to the MME 110 continuously as the information vectors are generated.

### Handling Integrated Presence and Location Information

The MME 110 and integrated E-SMLC 180 according to example embodiments of the present invention are capable of handling and processing integrated location and presence information generated by the eNB 120, as well as distributing the integrated location and presence information to customers. Examples of the structure and operation of the MME 110 and the E-SMLC 180 according to example embodiments of the present invention will now be discussed in greater detail.

Referring to FIG. 1, the MME 110 may include a database 112 and a filter unit 114. The database 112 stores information vectors received from the eNB 120. Though only one data database, database 112, is illustrated in FIG. 1, the MME 110 may include a database associated with each eNB connected to the MME 110. The filter unit 114 is capable of filtering the information vectors received from the eNBs connected to the MME 110. The filter unit 114 can also filter information vectors stored in databases within MME 110, for example, the database 112. The MME 110 includes hardware and/or software capable of producing a location/presence information flow 170 based on the information vectors provided by the eNB 120.

The integrated E-SMLC/SLP 180 is capable of performing the functions of an E-SMLC as well as an SLP. For example, as illustrated in FIG. 1, the integrated E-SMLC/SLP 180 may include an E-SMLC unit 182, which includes hardware and/or software capable of carrying out the functions of an E-SMLC. The integrated E-SMLC/SLP 180 may also include an SLP unit 184 which includes hardware and/or software capable of carrying out the functions of an SLP. The integrated E-SMLC/SLP may also include a location routing function (LRF) unit 186 which includes hardware and/or software capable of carrying out the functions of an LRF. The E-SMLC unit 182, the SLP unit 184, and the LRF unit 186 can share data with one another. Functions and operations of the eNB 120, MME 110, and E-SMLC 180 will be described in greater detail below.

As illustrated, the MME 110 provides the information flow 170 to the integrated E-SMLC/SLP 180. The operation of the integrated E-SMLC/SLP 180 will be discussed in greater detail below. The location/presence information flow 170 may include the location and presence information for all or a plurality UEs in the wireless communications network 100. Accordingly, the location/presence information flow 170 may be valuable for facilitating location based service (LBS) applications of corporate customers, which desire to make use of location and/or activity information for a large number of UE users.

For example, customers may purchase a subscription in order to access the location/presence information flow 170. Subscriptions can come in different varieties. For example, customers may purchase continuous real-time access to the location/presence information flow 170 or customers may purchase access to the location/presence information flow 170 for specific times of the day.

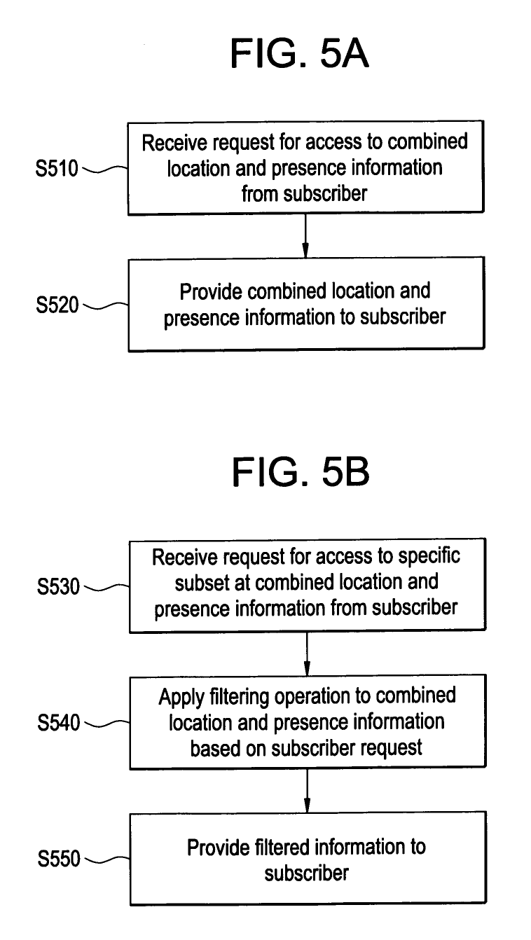

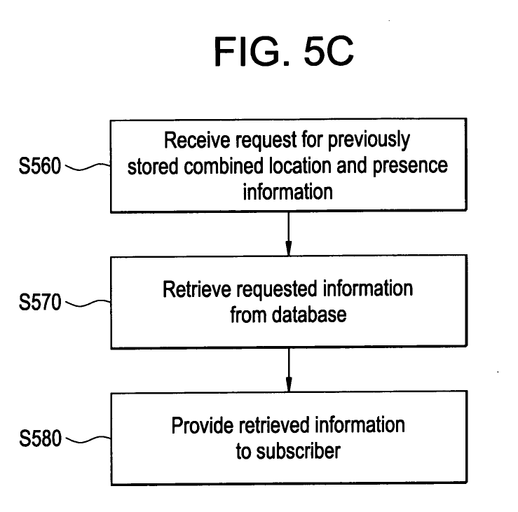

FIG. 5A is a flow chart illustrating a method of providing combined location and presence information to a subscriber. As an example, FIG. 5A will be discussed with reference to the MME 110 illustrated in FIG. 1. However, the operations discussed in FIG. 5A may also be performed by the integrated E-SMLC/SLP 180 after receiving the location/presence information flow 170 from the MME 110.

Referring to FIG. 5A, in step S510 the MME 110 receives a request for access to combined location and presence information in the location/presence information flow 170 from a subscriber. The access request includes an indication of the frequency with which the subscriber would like access to the combined location and presence information. As is discussed above, the subscriber can request real-time continuous access, or periodic access. The subscriber can also request one-time or non-repeating temporary access.

In step S520, the MME 110 provides the subscriber with access to the combined location and presence information of the location/presence information flow 170 in accordance with frequency indicated by the subscriber in step S510.

Some subscribes may only wish to have access to a specific subset of the combined location and presence information in the location/presence information flow 170. Accordingly, the MME 110 may use the filter unit 114 to process the raw information vectors received from the eNB 120 before generating the location/presence information flow 170 based on the needs of subscribing commercial customers. The MME 110 may also forward the information flow 170 to the integrated E-SMLC/SLP 180 for further processing in accordance with the needs of the subscribers. Accordingly, though not pictured, the integrated E-SMLC/SLP 180 may also include a filtering unit for processing the location/presence information flow 170 generated by the MME 110. Additionally, the MME 110 may also forward the location/presence information flow 170 to other network elements within wireless communications network 100 which include filter units for further processing.

Accordingly, a subscriber is able to request specific types of information within the information flow 170. For example, some subscribers may only wish to know the locations of UEs that download more than a threshold amount of data per day. As another example, some subscribers may only wish to know locations of mobiles which use text messaging. In either case, filter units within the wireless network 100, for example filter unit 114 of the MME 110, can process the information vectors received from the eNB 120 by applying a filter operation to provide a subscriber with only the information the subscriber requests.

FIG. 5B is a flow chart illustrating a method of providing a requested subset of the combined location and presence information to a subscriber. As an example, FIG. 5B will be discussed with reference to the MME 110 illustrated in FIG. 1. However, the operations discussed in FIG. 5B may also be performed by the integrated E-SMLC/SLP 180 after receiving the location/presence information flow 170 from the MME 110.

Referring to FIG. 5B, in step S530 the MME 110 receives a request for access to combined location and presence information in the location/presence information flow 170 from a subscriber. The access request includes an indication of a specific type of information the subscriber wishes to have access to. Parameters a subscriber can use to tailor a request for location and/or presence information include, for example, a location of mobile devices producing the information, a QoS associated with the mobiles producing the information, an amount of data transferred over a given period of time by the mobile devices producing the information, etc. Further, a subscriber may request only location information and not presence information, or presence information and not location information. Further, as discussed above with reference to step S510 of FIG. 5A, the access request received in step S530 includes an indication of the frequency with which the subscriber would like access to the combined location and presence information.

In step S540, the MME 110 applies a filter operation to the location/presence information flow 170 based on the desires of the subscriber as indicated in the access request received in step S530 and generates filtered location and/or presence information.

In step S550, the MME 110 provides the subscriber with access to the filtered location and/or presence information in accordance with frequency indicated by the subscriber in step S510.

In addition to providing a filtering operation, the MME 110 may also generate the location/presence information flow 170 using unprocessed information vectors. For example, the MME 110 may form the information flow 170 by passing information vectors received from the eNB 120 through the filter unit 114 without applying a filter operation. As a another example, the MME 110 may form the location/presence information flow 170 without passing the information vectors received from the eNB 120 through the filter unit 114.

Additionally, customers may be interested in the past behavior of large groups of UEs for analytical purposes. Accordingly, in addition to real-time, periodic and one-time temporary access, customers may purchase access to data that was provided by location/presence information flow 170 at a previous point in time or over a previous time period. The previously provided data may be provided from databases within the wireless network 100, for example the database 112 within the MME 110. Though not pictured, the integrated E-SMLC/SLP 180 may also include a database for storing previously provided data of the location/presence information flow 170. Further, wireless network 100 may include other network elements for storing data provided by the location/presence information flow 170.

FIG. 5C is a flow chart illustrating a method of providing previously stored combined location and presence information to a subscriber. As an example, FIG. 5C will be discussed with reference to the MME 110 illustrated in FIG. 1. However, the operations discussed in FIG. 5C may also be performed by the integrated E-SMLC/SLP 180 after receiving the location/presence information flow 170 from the MME 110.

Referring to FIG. 5C, in step S560 the MME 110 receives a request for access to combined location and presence information in the location/presence information flow 170 from a subscriber. As discussed above with reference to step S530 of FIG. 5B, the access request may include an indication of a specific type of information the subscriber wishes to have access to.

In step S570, the MME 110 retrieves the information requested by the subscriber in step S560. The MME 110 may retrieve the requested information from the data base 112. The MME 110 may also retrieve the requested information from another network element within wireless network 100 storing the requested information.

In step S580, the MME 110 provides the retrieved information to the subscriber.

As is illustrated in FIG. 1, the MME 110 provides the information flow 170 to the integrated E-SMLC/SLP 180. According to some example embodiments, the integrated E-SMLC/SLP 180 may provide the location/presence information flow 170 directly to servers or data processing units operated by subscribing customers so the subscribing customer can further process the location/presence information flow 170 in accordance with the specific needs of LBS applications operated by the subscribing customers. Further, in addition to providing the information flow 170 directly to the integrated E-SMLC/SLP 180 as illustrated in FIG. 1, the MME 110 may also provide the information flow 170 directly to the servers or data processing units of subscribing customers for further processing.

Further, by providing the information flow 170 to the integrated E-SMLC/SLP 180, the E-SMLC/SLP 180 can provide further processing of the information flow 170 in order to support LBS applications designed for use with a control plane architecture as well as LBS applications designed for use with a user plane architecture. Specifically, the E-SMLC unit 182 can share information back and forth with the SLP unit 184. For example, individual UEs within wireless network 100 making location requests using the user plane may provide the E-SMLC unit 182 with specific information that may not generally be available in the control plane including, for example, a GPS-based location of the individual UE, a specific LBS application being used by the individual UE, a permanent ID associated with the individual UE (e.g. an international mobile subscriber identity (IMSI), etc.).

As another example, the E-SMLC 182 unit may provide the SLP unit 184 with information from a base station almanac BSA. The BSA is typically maintained by network elements operating on the control plane and includes information relating to the eNBs operating within wireless network 100 including, for example, eNB coordinates, a number of sectors per cell, cell antenna beam orientation, transmitting power, transmitting and receiving path delays, etc. The accurate and frequently updated information within the BSA can be used to supplement functions handled by the SLP unit 184 which are usually associated with the user plane including assisted GPS (AGPS).

Accordingly, by providing the location/presence information flow 170 to the integrated E-SMLC/SLP 180, the integrated E-SMLC/SLP 180 is able to combine the location/presence information associated with all or a plurality of the UEs in communication with one or more eNBs in wireless communications network 100 with the more specific information from individual UEs requesting LBSs using the user plane. Further, the integrated E-SMLC/SLP 180 can use information generally available on the control plane, for example information within the BSA, to facilitate operations generally performed on the user plane, for example AGPS. Accordingly, the integrated E-SMLC/SLP 180 can use the combined location and presence information provided by the MME 110 to facilitate enhanced LBS applications.

Using the method for providing location and presence information according to the present invention, an information flow including information regarding all mobiles in a wireless network can be generated and used to support advanced applications which require, or can benefit from using, location and/or presence information for all or a plurality of mobiles in a wireless network. Examples of such advanced application will be discussed in greater detail below.

### Subscriber Use Cases

Example use cases for the novel location/presence information flow 170 generated by the MME 110 in accordance with the present invention will now be discussed. Each of the use cases will be described with reference to wireless communications network 100. Though only three use cases are discussed below, these cases are only as examples and it will be understood that there may be any number of different possible applications of the location/presence information flow 170 according to the present invention.

### First Use Case

A first example use case includes using the location/presence information flow 170 to provide traffic information. A company, Company X wants to provide traffic information to its customers. Company X subscribes to a service which provides Company X with continuous access to the location/presence information flow 170. Company X may receive the location/presence information flow at servers associated with Company X.

Company X processes the location/presence information flow 170 to track the location of each of the UEs in wireless communications network 100. Company X may use the continuously provided location/presence information flow 170 to calculate speed and direction values of travel for each of the UEs in wireless communications network 100. Company X may associate the calculated speed and direction values with a map, and provide the map to Company X's users in order to provide Company X's users with and approximation of the flow of traffic in a particular region.

Accordingly, Company X can provide Company X's customers with real-time approximations of traffic flow. Further, because, through the location/presence information flow 170, Company X has access to location/presence information for, potentially, all UEs within wireless communications network 100, Company X can provide to their customers, traffic flow information that covers a wide geographical area. Thus, Company X's customers can make informed route choices allowing the customers to avoid traffic.

### Second Use Case

Another example use case includes using the location/presence information flow 170 to analyze behavior patterns or large groups of UE users. A company, Company Y, provides video clips of wild animals to UE users. Company Y wants to determine where and/or when UE users typically view videos. Accordingly, Company Y subscribes to a service which provides Company Y with location and presence information provided by the location/presence information flow 170 over a specific time period. For example, Company Y may request access to a day's worth of information provided by the location/presence information flow 170.

Company Y analyzes the requested information to determine how many UEs engaged in streaming video, what times UEs were engaged in streaming video, and where UEs were located when streaming video. Company Y may then use, for example, the time and location information to determine the best types of ads to provide along with the wildlife videos. For example, if Company Y determines that a large number UEs stream videos in locations which correlate with subway tunnels during rush hour, Company Y can include ads that may appeal to rush hour subway users. If Company Y determines a large number of UEs stream videos in locations which correlate with an airport, Company Y can include ads which appeal to frequent travelers. Accordingly, Company Y can use UE user behavior information provided by the location/presence information flow to generated targeted ads for those who download Company Y's wildlife videos.

### Third Use Case

Another example use case includes using the location/presence information flow 170 to make business planning decisions. A company, Company Z, provides statistical assistance to other companies. Accordingly, Company Z subscribes to a service which provides Company Z with access to specific statistics generated based on the location/presence information flow 170. For example, Company Z may only be interested in a location of UEs. A potential business operator may be contemplating opening a pet store in a particular area. The potential business operator is aware that a competing pet store already exists in the same local area. The potential business operator can go to Company Z and request a traffic report from Company Z corresponding to the location of the existing pet store.

Through Company Z's subscription, Company Z can use the location information provided by the location/information flow 170 to generate a report including, for example, the volume of UEs that travel within the parking lot of the competing pet store. The report can track a volume of the UEs that travel within the parking lot of the competing pet store over a period of time. The potential business operator can then use the report to gauge the amount of business the competing pet store has and make a determination as to whether or not to open a pet store in the same region as the competing pet store. Accordingly, Company Z can use location information based on the location/information flow 170 to provide retail clients with buyer volume information which the retail clients can use to make business decisions.

### Support for E911

The wireless network 100 is also capable of supporting enhanced 911 (E911) services. As is discussed above, the wireless network 100 includes an integrated E-SMLC/SLP 180. Accordingly, the wireless network 100 is capable of supporting both a user plane approach to supporting E911 and a control plane based approach to handling E911.

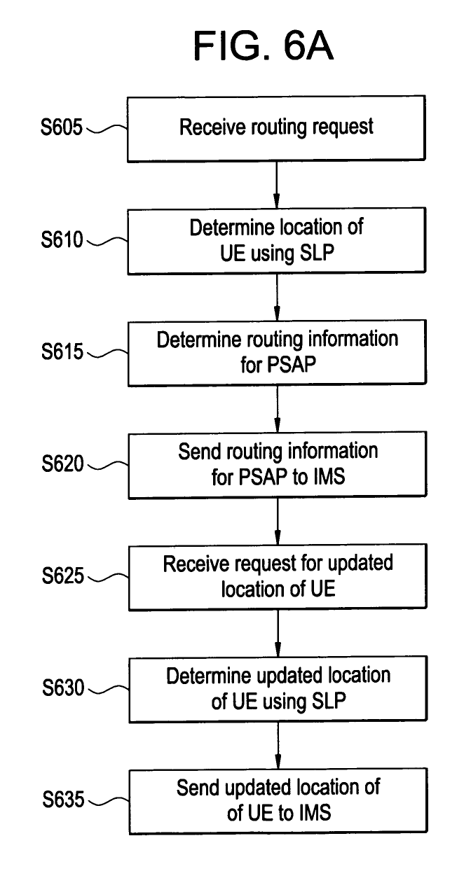

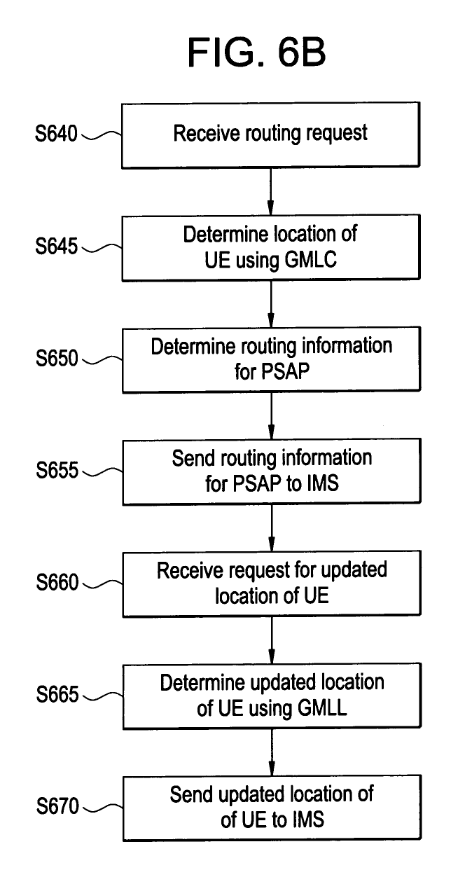

Methods for supporting E911 services in the unified architecture of wireless network 100 will now be discussed with reference to FIGS. 6A and 6B. As an example, FIGS. 6A and 6B will be discussed from the point of view of the integrated E-SMCL/SLP 180 in wireless network 100 illustrated in FIG. 1. The methods illustrated in FIGS. 6A and 6B will be described using an example in which the mobile 160A has already initiated an emergency call using E911 services within wireless network 100. The mobile 160A has already attached to the wireless network 100 using known emergency attaching procedures for LTE networks. Further, the mobile 160A has already sent a request to establish an emergency call to the IMS 196 via the serving gateway 192 and the PDN gateway 194, and the IMS 196 has generated a routing request for determining a path to the PSAP 198 in response.

FIG. 6A is a flow chart illustrating a method of supporting E911 services using a user plane approach. Referring to FIG. 6A, in step S605, the integrated E-SMLC/SLP 180 receives the routing request from the IMS 196. The routing request includes a request for routing information regarding the PSAP 198. The routing request may be received by, for example, the LRF 186. The LRF 186 may then forward the routing request to the SLP unit 184.

In step S610, the integrated E-SMLC/SLP 180 determines the location of the UE. For example, assuming the UE 160A is running a secure user plane client, the SLP unit 184 may determine the location of the UE 160A by communicating with the secure user plane client according to known methods of determining a location using an SLP.

In step S615, the integrated E-SMLC/SLP 180 determines the routing information for the PSAP 198. For example, the SLP unit 184 may forward the location of the UE 160 determined in step S610 to the LRF 186. The LRF 186 may use the location of the UE 160A to generate routing information regarding the PSAP 198 in any well known manner.

In step S620, the integrated E-SMLC/SLP 180 sends the routing information for the PSAP 198 determined in step S615 to the IMS 196. The IMS 196 then uses the routing information received from the integrated E-SMLC/SLP 180 to route the emergency call from the UE 160A to the PSAP 198.

In step S625, the integrated E-SMLC/SLP 180 receives a request for an updated location of the UE from the PSAP 198 via the IMS 196.

In step S630, the integrated E-SMLC/SLP 180 determines the updated location of the UE. The integrated E-SMLC/SLP 180 determines the current location of the UE 160A using in the same manner as described above with reference to step S610.

In step S635, the integrated E-SMLC/SLP 180 sends the updated location of the UE determined in step S630 to the IMS 196. The IMS 196 then sends the updated location of the UE 160A to the PSAP 198 where it can be used to direct emergency personnel including firefighters, police, emergency medical technicians, etc, to the location of the UE 160A.

It is possible that some mobile users, for example international roaming users, may not have UEs that support the SUPL 2.0 client. Accordingly, the user plane approach to E911 services illustrated in FIG. 6A will not work for these users. In order to provide support for these users, the wireless network 100 also supports the control plane approach to E911 services.

FIG. 6B is a flow chart illustrating a method of supporting E911 services using a control plane approach. Referring to FIG. 6B, in step S640, the integrated E-SMLC/SLP 180 receives a routing request from the IMS 196. The routing request includes a request for routing information regarding the PSAP 198. The routing request may be received by, for example, the LRF 186. The LRF 186 may then forward the routing request to the E-SMLC unit 182.

In step S645, the integrated E-SMLC/SLP 180 determines the location of the UE. The E-SMLC unit 182 may determine the location of the UE 160A using know methods of determining a location using an E-SMLC.

In step S650, the integrated E-SMLC/SLP 180 determines the routing information for the PSAP 198 in any well-known manner. For example, the E-SMLC unit 182 may forward the location of the UE 160 determined in step S610 to the LRF 186. The LRF 186 may use the location of the UE 160A to generate routing information regarding the PSAP 198.

In step S655, the integrated E-SMLC/SLP 180 sends the routing information for the PSAP 198 determined in step S615 to the IMS 196. The IMS 196 then uses the routing information received from the integrated E-SMLC/SLP 180 to route the emergency call from the UE 160A to the PSAP 198.

In step S660, the integrated E-SMLC/SLP 180 receives a request for an updated location of the UE from the PSAP 198 via the IMS 196.

In step S665, the integrated E-SMLC/SLP 180 determines the updated location of the UE. The integrated E-SMLC/SLP 180 determines the current location of the UE 160A using in the same manner as described above with reference to step S645.

In step S670, the integrated E-SMLC/SLP 180 sends the updated location of the UE determined in step S630 to the IMS 196. The IMS 196 then sends the updated location of the UE 160A to the PSAP 198 where it can be used to direct emergency personnel including firefighters, police, emergency medical technicians, etc, to the location of the UE 160A.

As is discussed above with reference to FIGS. 6A and 6B, the wireless network 100 can provide two routes to accessing E911 services. The resulting redundancy allows users of mobile devices to have a back up method of completing an emergency call. For example, if the E-SMLC/SLP 180 attempts to connect the UE 160A to E911 services using the user plane approach, and the attempt fails, the E-SMLC/SLP 180 can try again using the control plane approach. Further, if the E-SMLC/SLP 180 attempts to connect the UE 160A to E911 services using the control plane approach, and fails, the E-SMLC/SLP 180 can try again using the user plane approach.

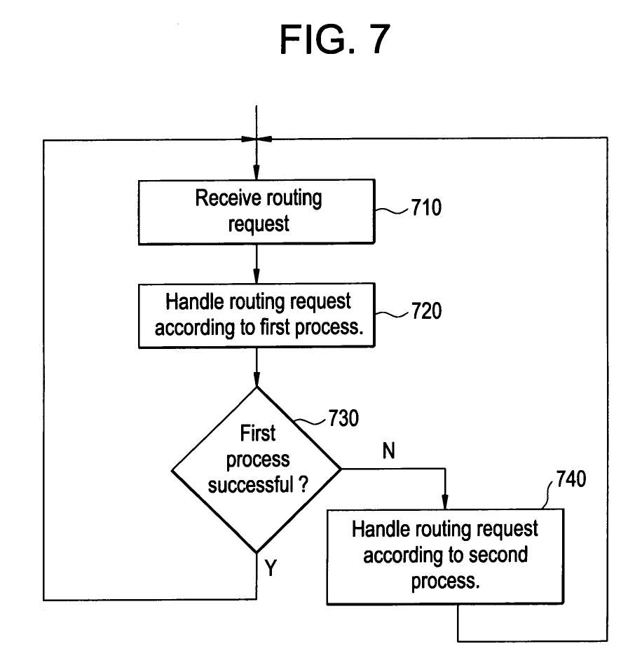

FIG. 7 is a flow chart illustrating a method of supporting E911 services using both a user plane approach and control plane approach. As an example, the method illustrated in FIG. 7 will be explained as is the user plane approach illustrated in FIG. 6A is a first process and the control plane approach illustrated in FIG. 6B is a second process. However, it will be understood that the control plane approach may also be the first process and the user plane approach may also be the second process. Referring to FIG. 7, in step S710, the integrated E-SMLC/SLP 180 receives the routing request from the IMS 196. The routing request includes a request for routing information regarding the PSAP 198. The routing request may be received by, for example, the LRF 186. The LRF 186 may then forward the routing request to the SLP unit 184.

In step S720, the E-SMLC/SLP 180 attempts to handle the routing request according to a first method. In step S720, the E-SMLC/SLP 180 proceeds to step S610 in FIG. 6A.

In step S730, the E-SMLC/SLP 180 determines whether the approach chosen as the first process in step S720 was successful. For example, if, while executing the steps illustrated in FIG. 6A, the E-SMLC/SLP 180 determines that the amount of time required to determine the location of the UE 160A using the SLP unit 184 in step S610 exceeds a threshold period of time, for example 15 seconds, the E-SMLC/SLP 180 may determine that the first process was not successful and proceed to step S740. Otherwise, the E-SMLC/SLP 180 may return to step S710.

In step S740, the E-SMLC/SLP 180 ceases attempting to handle the routing request received in step S710 using the first process, and handles the routing request using the second process. In step S740, the E-SMLC/SLP 180 proceeds to step S645 in FIG. 6B. Once the E-SMLC/SLP 180 completes the control plane approach, the E-SMLC/SLP 180 returns to step S710.

Accordingly, the wireless system 100 having a unified architecture including combined elements of a control plane and a user plane supports both a control plane approach to supporting E911 services and a user plane approach for supporting E911 services. Accordingly, users of UEs on the wireless system 100 are provided with more reliable access to E911 services in the event of an emergency.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or” includes any and all combinations of one or more of the associated listed items.

The terminology used herein is for the purpose of describing particular embodiments only and is not intended to be limiting of example embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The invention being thus described, it will be obvious that the same may be varied in many ways. Such variations are not to be regarded as a departure from the invention, and all such modifications are intended to be included within the scope of the invention.

What is claimed:

1. A method for generating combined location and presence information for a plurality of mobile devices in wireless communication with a base station, the method comprising:
collecting, at the base station, presence information for each of the plurality of mobile devices, respectively,
collecting, at the base station, location information for each of the plurality of mobile devices, respectively,
generating, at the base station, combined information for each of the plurality of mobile devices, respectively, based on the collected presence and location information.

2. The method of claim 1 wherein the generating step includes generating, for each of the plurality of mobile devices, an information vector associated with each of the plurality of mobile devices based on the collected presence and location information, the information vector including an identifier identifying the associated mobile device from among the plurality of mobile devices and time information indicating a time period during which presence and location information was collected.

3. The method of claim 1 further comprising:
performing call processing for each of the plurality of mobile devices, wherein the presence information is collected based on the call processing.

4. The method of claim 3 wherein, for each of the plurality of mobile devices, the presence information collected for the mobile device includes information regarding an activity of the mobile device.

5. The method of claim 4 wherein, the activity of the mobile device is one of participating in a voice call, texting and accessing the internet.

6. The method of claim 1, wherein the collecting location information step uses a geolocation function.

7. The method of claim 6, wherein the geolocation function includes location technologies that do not require consent of a mobile device user.

8. The method of claim 7, wherein the geolocation function includes using one of uplink observed time difference on arrival (U-OTDOA) and enhanced cell identification (ECID).

9. The method of claim 1 further comprising:
providing the information vectors generated to each of the plurality of mobile devices to a management entity.

10. The method of claim 9 further comprising:
generating, at the management entity, an information flow based on the information vectors generated for each of the plurality of mobile devices.

11. The method of claim 10 further comprising:
providing the information flow to one or more subscribers.

12. The method of claim 10 further comprising:
providing the information flow to an evolved serving mobile location center (E-SMLC).

13. The method of claim 10 further comprising:
providing the information flow to a secure user plane location (SUPL) location platform (SLP).

14. The method of claim 10 further comprising:
providing the information flow to a network element configured to perform the functions of both an E-SMLC and SLP.

15. A method of providing combined location and presence information for a plurality of mobile devices operating on a wireless network to a subscriber, the method comprising:
receiving, at a network element, an access request from a subscriber, the access request requesting access to the combined location and presence information, the network element being connected to the wireless network; and
providing, from the network element, access to the combined location and presence information.

16. The method of claim 15, wherein the network element is a management entity.

17. The method of claim 15, wherein the network element is configured to perform the functions of both an evolved serving mobile location center (E-SMLC) and a secure user plane location (SUPL) location platform (SLP).

18. The method of claim 15, wherein the access request includes an indication of a subset of information desired by the subscriber, and
wherein the providing step includes generating filtered information by applying a filtering operation to the combined location and presence information, and providing the filtered information to the subscriber.

19. The method of claim 15, wherein the combined location and presence information requested by the access request is previously stored information, and
wherein the providing step includes retrieving the previously stored information from a data base within the wireless network, and providing the retrieved information to the subscriber.

20. A method of handling an emergency call from a mobile device on a wireless network having a unified architecture, the method comprising:
receiving, at an integrated network element associated with the wireless network, a request for routing information for a public safety answering point (PSAP) from an IP multimedia subsystem (IMS), the integrated network element being configured to perform the functions of both an evolved serving mobile location center (E-SMLC) and a secure user plane location (SUPL) location platform (SLP), the request for routing information being associated with the emergency call;
attempting to determine, at the integrated network element, a location of the mobile device using a first process;
determining whether the location of the mobile device was successfully determined using the first process;
determining the location of the mobile device using a second process if the first process is determined not be successful;
determining, at the integrated network element, the routing information for the PSAP based on the determined location of the mobile device;
sending the routing information for the PSAP to the IMS so the IMS can connect the emergency call to the PSAP.

21. The method of claim 20, wherein the integrated network element includes an E-SMLC unit for implementing the functions of an E-SMLC and an SLP unit for implementing the functions of an SLP, the first process includes determining the location of the mobile device using the SLP, and the second process includes determining the location of the mobile device using the E-SMLC.
